(19) United States
(12) Patent Application Publication
(10) Pub. No.: US 2004/0010450 A1
(43) Pub. Date: Jan. 15, 2004

(54) Sales device

(76) Inventors: Gebhard Wallisch, Burladingen (DE); Herbert Murdter, Albstadt (DE); Holger Moritz, Albstadt (DE)

Correspondence Address: Friedrich Kueffner, Suite 910, 317 Madsion Avenue, New York, NY, 10017, US

(21) Appl. No.: 10/344,829

(22) PCT Filed: Jul. 26, 2001
(86) PCT No.: PCT/EP01/08677

(30) Foreign Application Priority Data
Aug. 14, 2000 (DE) 100 39 667.4

(51) Int. Cl. G06F 17/60

(52) U.S. Cl. 705/20

(57) ABSTRACT

The invention pertains to a device for use in connection with the sale of merchandise in a store or for use in a warehouse, with a unit which can be operated to generate merchandise-specific signals and a display unit which can be operated to display visually the merchandise-specific data represented by the merchandise-specific signals, where a driver circuit, which can be operated to receive signals representing images of at least part of the store or warehouse and to drive the display unit to display visually the images represented by these signals is assigned to the display unit.

The invention pertains to a device for use in connection with the sale of merchandise in a store or for use in a warehouse with a unit which can be operated to generate merchandise-specific signals and with a display unit which can be operated to display visually the merchandise-specific data represented by the merchandise-specific signals.

Devices of this type are used both in specialty stores and in supermarkets in the form of a scales and/or cash registers. Such devices are also used in the form of scales in warehouses. It is usually necessary for sales personnel to be present to operate these devices. Especially when these types of devices are used in supermarkets, however, it often occurs that the sales areas equipped with such devices, such as the check-out areas and the sales counters for cold cuts, cheese, fruit, etc., have few if any customers for certain periods of time. Nevertheless, it is usually necessary for all the sales areas to be staffed continuously by appropriate sales personnel to operate the sales devices, because it must be guaranteed that customers can be served at all times in all departments.

This leads to the problem that there are at least certain periods of time when full use cannot be reasonably made of the sales personnel.

In view of this problem, the invention is based on the task of providing sales devices of the type described above by means of which full use of the sales personnel can be reasonably made even when there are few if any customers in their sales areas.

This problem is solved according to the invention by an elaboration of the known sales devices, which is characterized essentially in that a driver circuit, which can be operated to receive signals representing images of least part of the store or warehouse and to actuate the display unit to display visually the images represented by these signals, is assigned to the display unit. Within the scope of this description, the term “driver circuit” is used to mean any electronic circuit by means of which it is possible, on the basis of the image signals or image data, to generate display signals suitable for generating a visual display of the images represented by the image signals on the display unit. The driver circuits can be in the form of appropriately modified graphics cards or a graphics subsystem possibly integrated into an existing microprocessor system. Appropriate video inputs for supplying the image signals can be assigned to the driver circuit.

This invention is based on the insight that the performance capacity of the display units of modern scales and cash registers, which are usually designed in the form of cathode-ray tubes, LCD screens, plasma screens, etc., goes far beyond the visual representation of merchandise-specific data and can also be used to display, for example, visual images of the store which are being recorded by a surveillance camera. On the basis of this insight, the possibility is created by the present invention of using sales devices to keep other sales areas under surveillance during periods of slow demand in the sales areas where these other devices are installed by adapting the rest of the hardware of the sales device to the capacities of the display unit. With the help of the sales devices elaborated in accordance with the invention, sales personnel can be fully occupied with meaningful work even in cases where their individual sales areas are only lightly frequented by assigning a surveillance task to these sales personnel. As a result, the manpower otherwise required to perform the surveillance activities can be at least partially eliminated. In addition, as a result of the elaborated sales devices according to the invention, a very low-cost surveillance system becomes available, because certain individual elements of the sales devices which would be required in any case, namely, their display units, can be used simultaneously as components of the surveillance system, which means that it is no longer necessary to purchase separate security monitors. Through the selection of appropriate driver circuits for the sales devices according to the invention, conventional security cameras can be used to generate the signals representing the images of the store, so that, in comparison to conventional surveillance systems, it is not necessary to spend any extra money to buy special security cameras adapted to the sales device according to the invention. The image signals from the security cameras can be sent over appropriate signal lines to the sales devices. In addition, however, the invention also includes the idea of the wireless transmission of these image signals. Already existing LAN connections, the Internet, or an intranet can also be used to transmit the image signals.

In comparison to conventional surveillance systems with surveillance mirrors which can also be used by the sales personnel, the use of a sales device elaborated according to the invention offers the advantage that, as long as the security cameras are installed appropriately, the entire store can be monitored with almost no gaps at all. In addition, the sales personnel at the sales counters can also keep auxiliary rooms under surveillance. An additional advantage of the use of sales devices according to the invention to keep the salesrooms under surveillance is that the number of surveillance stations and the number of security personnel and thus the effectiveness of the surveillance system can be increased beyond that of conventional surveillance systems without incurring additional costs for personnel.

The effectiveness of a surveillance system realized with the use of sales devices according to the invention can be increased by installing two or more security cameras in the store. In this case, it has been found favorable for the driver circuit of the sales device according to the invention to be capable of operating so that it can receive image signals from at least two signal sources, such as two security cameras, and to drive the display unit to produce a visual display of the images represented by the image signals from one or more signal sources. Embodiments are included in which two or more images are shown simultaneously in appropriate windows of the display unit. The idea of the visual display of only one image, however, is also included, where the signal source in question, whose image signals are to be displayed, is freely selectable. For this purpose, the driver circuit can be preceded by a central routing unit, possibly installed separately from the sales device, by means of which the image signals are transferred to the driver circuit, where this routing device is designed to handle the selective transfer of the image signals from one or more signal sources to one or more driver circuits. In this way, it is possible, with the use of only one central routing device, to supply a plurality of sales devices according to the invention with image signals, where at the same time the central routing device also determines which image signals are transmitted to the individual sales devices and displayed on them. Alternatively or in addition, the sales device itself can also be equipped with a selection unit for selecting the signal source, the image signals of which are used to drive the display unit. In this case, if the selection unit can also be operated in such a way as to select the signal sources whose image signals are to be used to drive the display unit of one or more additional sales devices, the sales device itself can be used as a central surveillance unit for a plurality of sales devices elaborated in accordance with the invention.

In many cases, only a selected, especially trustworthy group of sales personnel is to be used for surveillance activities. For this purpose, the sales devices according to the invention can be equipped with a release unit, which receives user-specific data. As a function of the user-specific data, this unit generates release signals, which release the visual display of the images represented by the image signals. These user-specific data can be entered into the sales device equipped with an appropriate input unit in the form of, for example, the so-called log-in code of the salesclerk. In addition, however, the idea of using other, especially automatic, recognition systems for generating the user-specific data is also included. The especially trustworthy employees to be used for surveillance purposes can also be equipped with appropriate release keys, cards, and/or transponders, which are used to generate the release signals.

Alternatively or in addition, devices according to the invention can also be equipped with a unit for detecting the operational status of the device. As a function of the detected operational status, this unit generates the release signals which release the visual display of the images represented by the image signals. With these types of status detection units, it is possible, for example, to detect whether or not a salesclerk has logged into the corresponding sales device, so that the release signals are not generated and thus the visual display of the images represented by the image signals is not produced until after an appropriate log-in has occurred. In addition, it is also possible with this status detection unit to detect whether or not the sales device is currently being used for a sales transaction. For example, the unit can detect the actuation of the keyboard of a sales device designed in the form of a cash register and/or detect the placement of an item on the weighing cell of a sales device designed in the form of a scale. The release signals are generated only when no sales process has been detected over a relatively long period, preferably a freely selectable period. In this way, the goal can be achieved that no surveillance images are shown on the display unit during the sales transaction itself. In addition, however, the idea of using embodiments in which the surveillance images are shown simultaneously with the merchandise-specific data is also included, so that surveillance can be conducted continuously. Finally, the idea is also included of using detection devices which generate the release signals in response to the actuation of corresponding input units, which would be used, for example, when the salesclerk, in a suspicious case, wants to interrupt the sales transaction briefly in order to observe a suspicious situation more closely and/or to trigger an alarm.

As already explained above, the sales device according to the invention can be realized in the form of a scale when it has a unit for generating merchandise-specific signals in the form of a weighing cell, which generates merchandise-specific signals representing the weight of the merchandise. In addition, the device according to the invention can also be realized in the form of a cash register. For this purpose, the device is advisably equipped with an input unit, such as a keyboard, scanner, etc., to generate merchandise-specific data representing the price of the merchandise.

A surveillance system produced with the use of devices according to the invention comprises at least one device according to the invention and also at least one unit for generating image signals representing images of at least part of the store. This image signal-generating unit can be realized, for example, in the form of an analog or digital camera (video camera) or a photographic apparatus.

A method according to the invention for keeping a store under surveillance by a surveillance system according to the invention is characterized essentially in that the image signal-generating unit generates image signals representing images of at least part of the store and transmits them to one or more sales devices according to the invention, by means of which the images represented by the image signals are displayed and monitored by the sales personnel.

The devices according to the invention, intended for use in conjunction with the sale of merchandise, can also be used in warehouses. In this case, too, it is possible with the help of these devices to construct a surveillance system, by means of which, for example, suppliers or other warehouse workers can be kept under surveillance.

The invention is explained below on the basis of the drawing, to which reference is explicitly made for all of the details which are essential to the invention but which have not been discussed in detail in the specification. In the drawing:

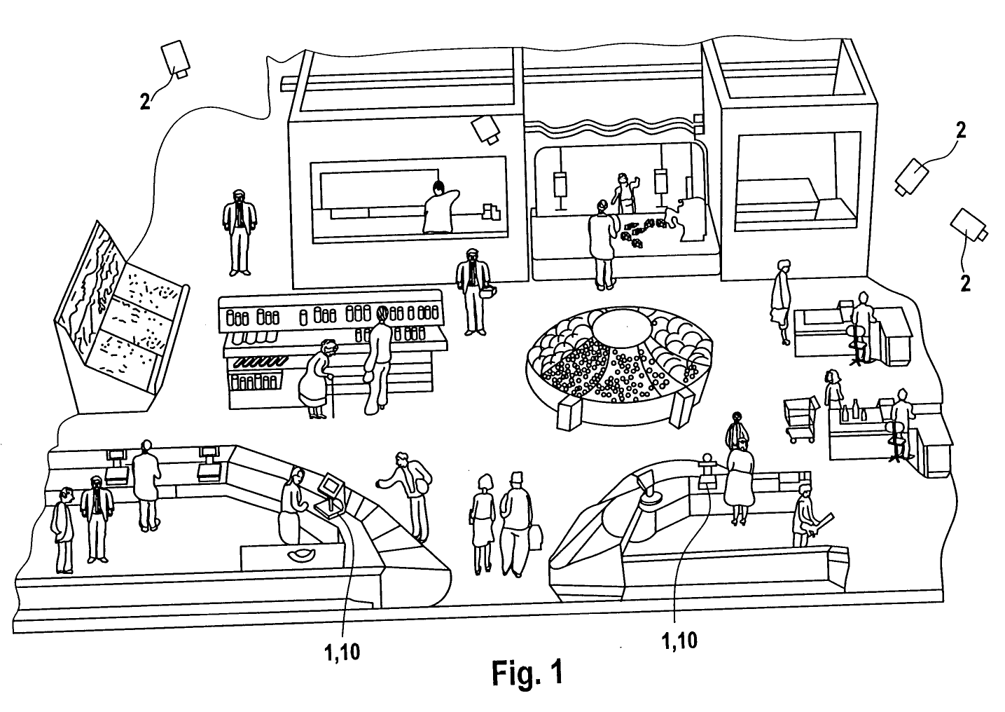

FIG. 1 shows part of a salesroom equipped with a surveillance system according to the invention;

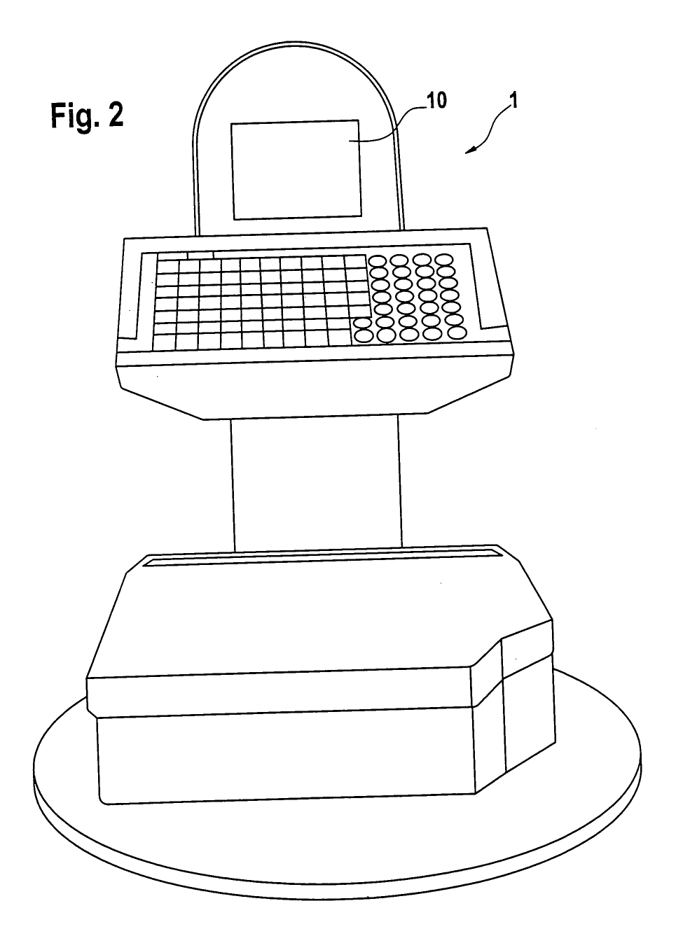

FIG. 2 shows a view of a sales device according to the invention in the form of a scale; and

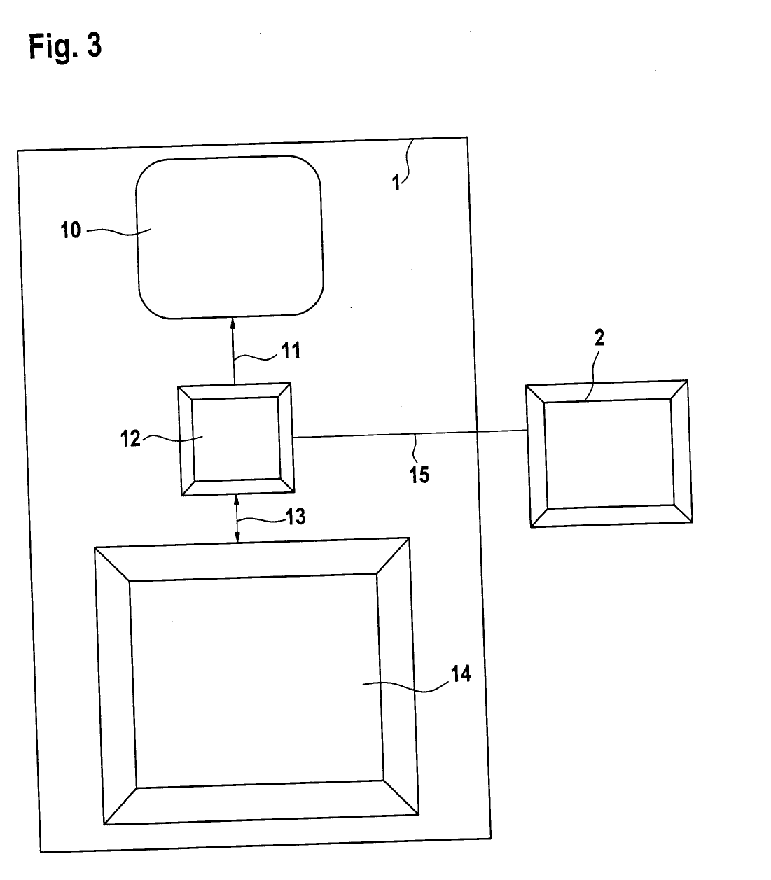

FIGS. 3-7 show various embodiments of surveillance systems according to the invention.

The surveillance system shown schematically in FIG. 2 comprises a total of four security cameras 2 and a plurality of devices 1 according to the invention in the form of scales and cash registers. The image signals generated by the security cameras are sent to a separate central routing unit, not shown in the drawing, and from there they are sent on to the individual sales devices. The images represented by the image signals sent to these sales devices 1 are displayed on the display unit 10, with which each device is equipped, as soon as a salesclerk has logged on and no sales transaction has occurred over a prolonged period of time. The individual sales devices are also equipped with input units, which can be actuated by the sales personnel. These input units can be used to initiate the visual display of the images represented by the image signals on the display units 10 even during a sales transaction, if the salesclerk detects a suspicious situation. The individual scales and cash registers according to the invention are equipped with appropriate driver circuits, which receive the image signals. These circuits drive the display units 10 to display visually the images represented by the image signals. In addition to the cash registers and scales shown in FIG. 1, the surveillance system according to the invention can also have one or more combination scale and cash register units. The individual sales devices can be equipped with display units in the form of cathode-ray tubes or plasma screens. In the case of the preferred embodiment shown in FIGS. 1 and 2, the display units are realized in the form of LCD screens. In the case of the sales devices shown in the drawing, the image signals are sent over appropriate signal lines. The image signals could, however, be transmitted by wireless means.

The surveillance system shown in FIG. 3 consists essentially of a sales device 1, such as scale, and a signal source, such as a video camera, a photographic apparatus, etc. The sales device 1 comprises a central control unit 14, by means of which merchandise-specific data such as data representing the weight of merchandise are generated. These merchandise-specific data are sent over a bus 13 to a driver circuit 12 for the display unit 10, which is realized in the form of a graphics subsystem. The display signals which produce the images of the merchandise-specific data on the display unit 10 are generated in the graphics subsystem. In addition, the graphics subsystem 12 also receives image signals from the signal source 2, these signals being sent through a video input (not shown) and a corresponding signal line 15.

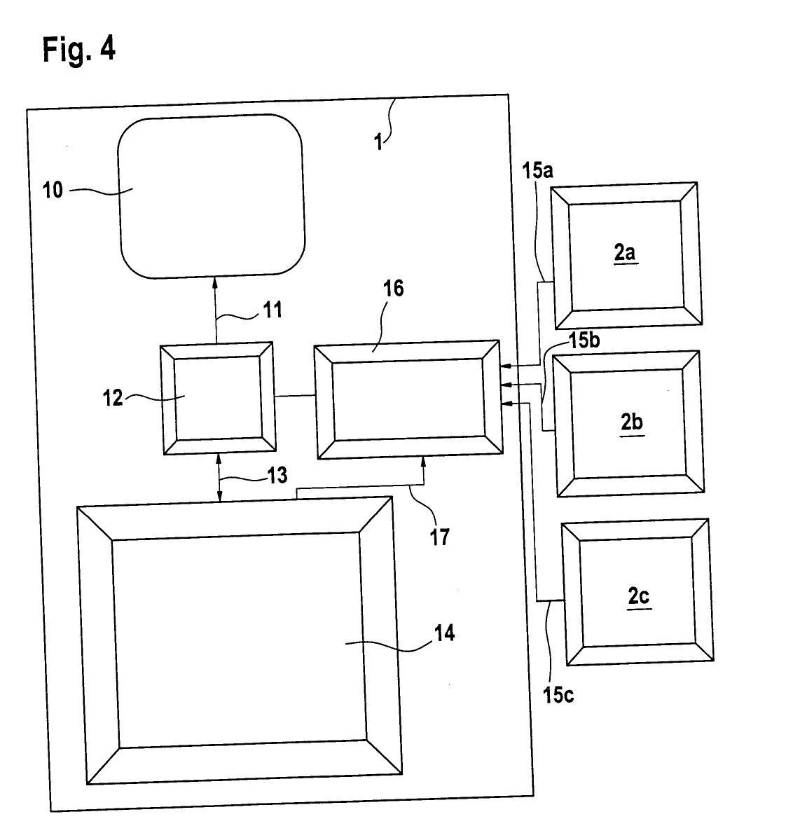

The embodiment shown in FIG. 4 differs from the embodiment explained in conjunction with FIG. 3 essentially only in that the sales device 1 is designed to generate an image display of the image signals originating from a total of three different signal sources 2a, 2b, and 2c. For this purpose, the device 1 has an additional selection unit 16, to which the image signals originating from the signal sources 2a, 2b, and 2c are sent via signal lines 15a, 15b, and 15c. Control signals are generated by the central control unit 14 and sent over a signal line 17 to the selection unit 16. As a function of the control signals sent over the signal line 17, the selection unit 16 is used to send one or more of the image signals arriving via the image signal lines 15a, 16b, and 16c to the graphics subsystem 12, i.e., to the driver circuit. The driver circuit 12 then generates the display signals which are able to produce the visual display of the images selected by the selection device 16 on the display unit 10 and then sends these signals over the signal line 11 to the display unit 10.

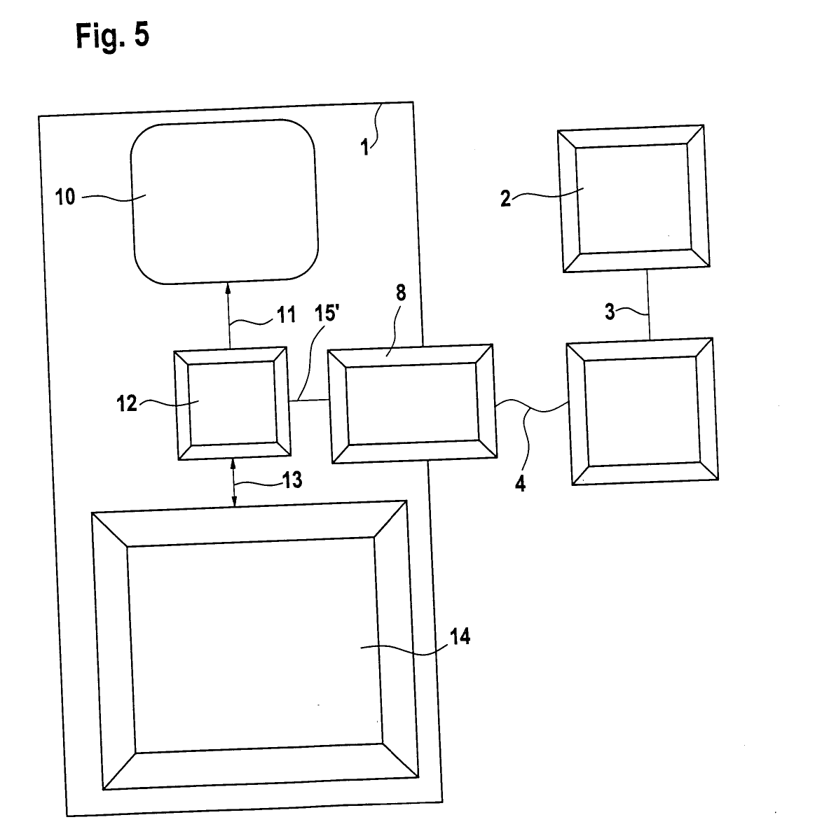

The embodiment of the invention illustrated in FIG. 5 corresponds for the most part to the embodiment shown in FIG. 3. The image signals in the case of the embodiment according to FIG. 5, however, are first sent from the signal source 2 over a signal line 3 to a converter unit 4. The converter unit 4 comprises a transmitter, which is designed for the wireless transmission of signals corresponding to the image signals. For this purpose, the image signals sent over the signal line 3 are converted to corresponding radio or infrared signals for transmission to the device 1. The device 1 is equipped with a receiving unit 8 suitable for receiving these radio or infrared signals. On the basis of the wireless signals, the receiving unit 8 generates image signals again and sends them over a signal line 15′ to the driver circuit 12.

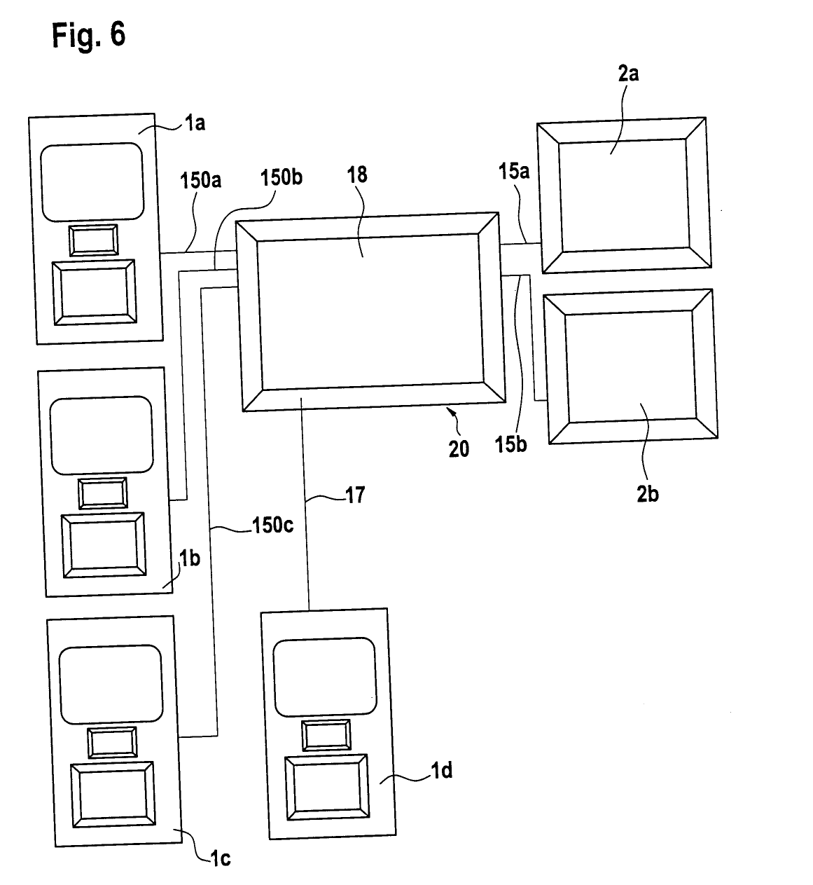

The embodiment of the invention shown in FIG. 6 comprises a total of four sales devices 1a, 1b, 1c, 1d according to the invention and two signal sources 2a, 2b. The image signals originating from the signal sources 2a and 2b are sent over signal lines 15a, 15b to a central surveillance unit 20. The central surveillance unit 20 comprises a selection unit 16′, by means of which it is determined which image signals are sent to which sales device. As a function of appropriate control signals generated by the selection unit 16′, the image signals are caused to be sent to the corresponding sales devices with the help of a routing unit 18 present in the central surveillance unit. The central surveillance unit can be controlled by one of the sales devices; in the drawing, it is being controlled by the sales device 1d. In this case, the sales device 1d is used to determine merchandise-specific data, to display visually the images represented by the image signals, and also to select the signal source whose image signals are to be used to drive the display units of the other sales devices 1a, 1b, and 1c.

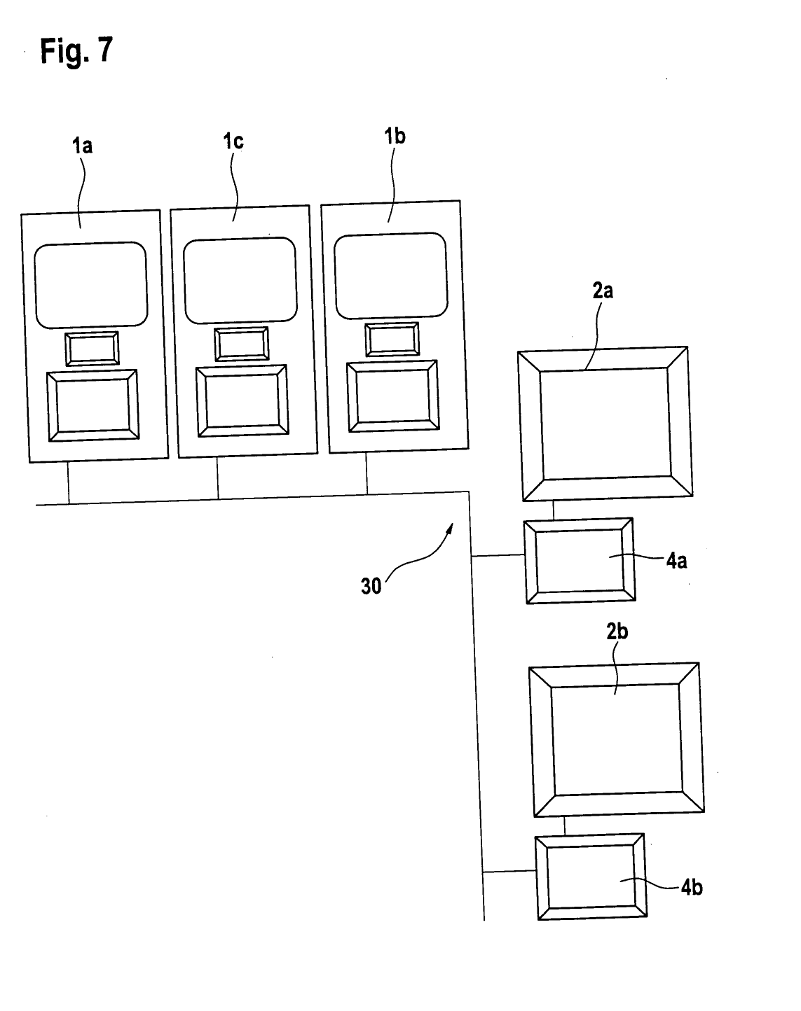

The embodiment of the invention shown in FIG. 7 comprises three sales devices 1a, 1b, and 1c and two signal sources 2a and 2b. In this embodiment, all the sales devices and signal sources are connected to a network 30, which may already have been present. This network can be realized in the form of, for example, a LAN, a radio network, an infrared network, or the Internet. The image signals originating from the signal sources 2a and 2b are converted by appropriate converter circuits 4a and 4b into data compatible with the network 30 and sent over the network 30 to the sales devices, in which then the visual display of the images represented by the image signals can occur. For this purpose, a routing and selection unit of the type shown in FIG. 6 can, for example, be used to select the image signals for the individual sales devices. In addition, each one of the sales devices, however, can also have its own selection device of the type shown in FIG. 4. When a wireless signal transmission system is used, the converter units 4a and 4b of the type explained on the basis of FIG. 5 can be realized for the converter unit 4, and each of the sales devices can also comprise a receiving unit of the type explained on the basis of FIG. 5.

When sales devices according to the invention are used to construct a surveillance system, the personnel operating the weighing units and cash registers can simultaneously act as surveillance personnel. This surveillance activity can be conducted by the sales personnel in addition to their sales activities such as weighing merchandise and/or goods or in addition to their activity of registering the receipt of money. In this way, the number of surveillance stations and the number of surveillance personnel can be increased overall without increasing the actual number of employees required, which improves the efficiency of the surveillance system and lowers the theft rate.

It is possible with the surveillance system according to the invention to install a plurality of low-cost surveillance units in the store or warehouse to be monitored and to allow the sales personnel to monitor at-risk areas from their weighing units or cash registers. In a surveillance system built with the use of sales devices according to the invention, a plurality of weighing units or cash registers is available to display the surveillance images, which means that it is possible for surveillance to be conducted continuously and without any visual gaps.

1. Device for use in connection with the sale of merchandise in a store or for use in a warehouse, with a unit which can be operated to generate merchandise-specific signals and a display unit which can be operated to display visually the merchandise-specific data represented by the merchandise-specific signals, characterized in that a driver circuit, which can be operated to receive signals representing images of at least part of the store or warehouse and for driving the display unit to display visually the images represented by these signals is assigned to the display unit.

2. Device according to claim 1, characterized in that the driver circuit can be operated to receive image signals from at least two signal sources (2) and to drive the display unit (10) to display visually the images represented by the image signals from one or more signal sources (2).

3. Device according to claim 1 or claim 2, characterized in that a routing unit is installed in front of the driver circuit to transfer the image signals to the driver circuit.

4. Device according to claim 3, characterized in that the routing unit is designed to transfer selectively the image signals of several signal sources to one or more driver circuits.

5. Device according to one or more of claims 2-4, characterized in that the device has a selection unit for selecting the signal source (2) whose image signals are to be used to drive the display unit (10).

6. Device according to claim 5, characterized in that the selection unit can be operated to select the signal source whose image signals are to be used to drive the display unit (10) of an additional sales device (1).

7. Device according to one of the preceding claims, characterized by a release unit which receives user-specific data and which, as a function of the user-specific data, generates the release signals which release the visual display of the images represented by the image signals.

8. Device according to one of the preceding claims, characterized by a unit which detects the operational status of the device (1) and which, as a function of the detected operational status, generates the release signals which release the visual display of the images represented by the image signals.

9. Device according to one of the preceding claims, characterized by a unit which generates merchandise-specific signals in the form of signals representing the weight of the merchandise.

10. Device according to one of the preceding claims, characterized by an input unit which generates merchandise-specific signals representing the price of the merchandise.

11. Surveillance system with at least one device (1) according to one of the preceding claims and at least one unit (2) for generating image signals representing images of at least part of the store or warehouse.

12. Surveillance system according to claim 11, characterized by a network such as an intranet, the Internet, or LAN connections for the transmission of the image signals.

13. Method for monitoring a store or warehouse with a surveillance system according to claim 11 or claim 12.
